(19) United States
(12) Patent Application Publication
(10) Pub. No.: US 2011/0115441 A1
(43) Pub. Date: May 19, 2011

(54) CHARGING CONTROL METHOD, CHARGING CONTROL COMPUTER PROGRAM, CHARGING CONTROL DEVICE, SECONDARY CELL SYSTEM, SECONDARY CELL POWER SUPPLY, AND CELL APPLICATION DEVICE

(76) Inventors: Takahiro MATSUYAMA, Osaka (JP); Naoto Nishimura, Osaka (JP)

(21) Appl. No.: 12/942,300

(22) Filed: Nov. 9, 2010

(30) Foreign Application Priority Data
Nov. 18, 2009 (JP) 2009-262926

(51) Int. Cl. H02J 7/00

(52) U.S. Cl. 320/150

(57) ABSTRACT

A charging control method for a non-aqueous electrolyte secondary cell is a charging control method for controlling a state of charge of a non-aqueous electrolyte secondary cell that has a non-aqueous electrolyte between electrodes, a target state of charge serving as a target for stopping charging is preset in correspondence with an ambient temperature of the non-aqueous electrolyte secondary cell, and the target state of charge (e.g., 95%) for when the ambient temperature is a specific temperature (e.g., 25° C. or 20° C. to 30° C.) that has been specified in advance is set higher compared to the target state of charge for a temperature other than the specific temperature.

### CROSS-REFERENCE TO RELATED APPLICATION

This application claims priority under 35 U.S.C. §119(a) on Patent Application No. 2009-262926 filed in Japan an Nov. 18, 2009, the entire contents of which are herein incorporated by reference.

### BACKGROUND OF THE INVENTION

The present invention relates to a charging control method for a non-aqueous electrolyte secondary cell, a charging control computer program, a charging control device, a secondary cell system, a secondary cell power supply, and a cell application device.

Non-aqueous electrolyte secondary cells (e.g., lithium ion cells) having a non-aqueous electrolyte are receiving attention because, given the application of a non-aqueous electrolyte, a higher voltage than the water electrolysis voltage can be obtained, and the amount of stored energy is large. Thus, such non-aqueous electrolyte secondary cells are now being applied as a power supply for various electronic devices or as a power supply for vehicles, for instance.

Further, non-aqueous electrolyte secondary cells need to be charged, and various proposals on charging of the non-aqueous electrolyte secondary cells have also been made. Furthermore, some problems concerning the temperature characteristics associated with charging of the non-aqueous electrolyte secondary cells have been pointed out.

For example, there has been proposed a cell control method (e.g., see JP 2002-345165A (hereinafter, referred to as Patent Document 1)) for maintaining the output characteristics constant by increasing the state of charge (SOC) the lower the temperature of the cell, that is, by giving a negative correlation between the temperature and the state of charge.

Further, it has been proposed to extend the life of a secondary cell (e.g., see JP 2009-514504A (hereinafter, referred to as Patent Document 2) by setting the securement of a high state of charge at a low temperature and a low state of charge at a high temperature as a target value/temperature characteristic curve, and performing charging control for matching the state of charge to target values.

However, the conventional charging control technology has the following problems.

Ordinarily, non-aqueous electrolyte secondary cells, especially lithium ion cells, tend to have a lower capacity at low temperatures, and have a higher possibility of precipitation of metallic lithium as the state of charge increases. Further, if the metallic lithium precipitates and becomes foreign matter between the electrodes, which may damage the separator and cause an internal short circuit between the positive and negative electrodes, for instance, and thus safety may be markedly compromised.

### SUMMARY OF THE INVENTION

The present invention has been conceived under such circumstances, and an object of the present invention is to provide a charging control method for improving safety and reliability of a non-aqueous electrolyte secondary cell by configuring the present invention as a charging control method in which a preset target state of charge for a specific temperature is set higher than target states of charge for temperatures other than the specific temperature (higher temperatures than the specific temperature and lower temperatures than the specific temperature).

Further, another object of the present invention is to provide a charging control computer program for improving safety and reliability of a non-aqueous electrolyte secondary cell by configuring the present invention as a charging control computer program for causing a computer to execute the charging control method according to the present invention.

Further, another object of the present invention is to provide a charging control device for executing the charging control method according to the present invention, and for improving safety and reliability of a non-aqueous electrolyte secondary cell.

Further, another object of the present invention is to provide a secondary cell system that includes the charging control device according to the present invention and a non-aqueous electrolyte secondary cell serving as a target for charging, and is for improving safety and reliability of a non-aqueous electrolyte secondary cell.

Further, another object of the present invention is to provide a secondary cell power supply that includes the secondary cell system according to the present invention and a charging power supply for supplying charging power, is efficient and economical, and is for improving safety and reliability of a non-aqueous electrolyte secondary cell.

Further, another object of the present invention is to provide a cell application device that is equipped with the secondary cell system according to the present invention, has high safety and reliability, and is for improving safety and reliability of a non-aqueous electrolyte secondary cell.

The charging control method according to the present invention is a charging control method for controlling a state of charge of a non-aqueous electrolyte secondary cell that has a non-aqueous electrolyte between electrodes, a target state of charge serving as a target for stopping charging is preset in correspondence with an ambient temperature of the non-aqueous electrolyte secondary cell, and the target state of charge for when the ambient temperature is a specific temperature that has been specified in advance is set higher compared to the target state of charge for a temperature other than the specific temperature.

Accordingly, with the charging control method according to the present invention, the target states of charge are set such that the non-aqueous electrolyte secondary cell is charged up to a relatively high target state of charge when the ambient temperature is the specific temperature, and the non-aqueous electrolyte secondary cell is charged up to a relatively low target state of charge compared to the target state of charge for the specific temperature when the ambient temperature is other than the specific temperature. Thus, generation of a precipitate in the non-aqueous electrolyte can be prevented on the low temperature side, and ignition due to the non-aqueous electrolyte can be prevented on the high temperature side. Accordingly, it is possible to perform charging up to an optimal state of charge adapted to the ambient temperature, and thus safety and reliability of the non-aqueous electrolyte secondary cell can be improved.

Further, with the charging control method according to the present invention, when the ambient temperature is lower than the specific temperature, the target state of charge may be set so as to change positively with respect to a positive change in temperature, and when the ambient temperature is higher than the specific temperature, the target state of charge may be set so as to change negatively with respect to a positive change in temperature.

Accordingly, with the charging control method according to the present invention, charging on the low temperature side and the high temperature side is controlled more effectively, and thus safety and reliability of the non-aqueous electrolyte secondary cell can be further improved.

Further, with the charging control method according to the present invention, the ambient temperature may be a temperature of an envelope of the non-aqueous electrolyte secondary cell, or a temperature of an envelope of a secondary cell module that includes a plurality of the non-aqueous electrolyte secondary cells.

Accordingly, with the charging control method according to the present invention, the temperature of the non-aqueous electrolyte secondary cell can be directly detected, and thus charging can be controlled with ease and high precision.

Further, with the charging control method according to the present invention, the ambient temperature may be a temperature of a place where the non-aqueous electrolyte secondary cell is disposed.

Accordingly, with the charging control method according to the present invention, the state of charge can be controlled before the non-aqueous electrolyte secondary cell is influenced by and reaches a state of equilibrium with the temperature of the place where the cell is disposed, and in the case where the cell is installed outdoors, for example, the state of charge can be controlled to reflect the temperature of the outdoor environment.

Further, with the charging control method according to the present invention, the non-aqueous electrolyte secondary cell may be a lithium ion cell.

Thus, with the charging control method according to the present invention, charging control on lithium ion cells can be performed in the state where high safety and reliability are secured.

Further, with the charging control method according to the present invention, the specific temperature may be in a range from 5° C. to 40° C.

Thus, with the charging control method according to the present invention, safety and reliability of the non-aqueous electrolyte secondary cell can be reliably improved with regard to various target states of charge.

Further, with the charging control method according to the present invention, the specific temperature may have a temperature width, and the target state of charge for when the ambient temperature is within the temperature width may be set to a constant value.

Accordingly, with the charging control method according to the present invention, the non-aqueous electrolyte secondary cell can be charged up to the highest state of charge at the various temperatures within the above temperature width.

Further, the charging control computer program according to the present invention is a charging control computer program for causing a computer to execute control of a state of charge of a non-aqueous electrolyte secondary cell that has a non-aqueous electrolyte between electrodes, the computer program causing the computer to execute: a first step of detecting an ambient temperature of the non-aqueous electrolyte secondary cell; a second step of extracting, from an ambient temperature/target state of charge correlation characteristic obtained by presetting a target state of charge serving as a target for stopping charging in correspondence with the ambient temperature, the target state of charge in correspondence with the ambient temperature detected in the first step; a third step of detecting a state of charge of the non-aqueous electrolyte secondary cell as an actual state of charge; a fourth step of comparing the target state of charge and the actual state of charge; and a fifth step of executing charging of the non-aqueous electrolyte secondary cell when the actual state of charge is lower than the target state of charge.

Accordingly, with the charging control computer program according to the present invention, the state of charge is controlled based on the ambient temperature/target state of charge correlation characteristics obtained by presetting target states of charge serving as targets for stopping charging of the non-aqueous electrolyte secondary cell in correspondence with ambient temperatures. Thus, generation of a precipitate in the non-aqueous electrolyte can be prevented on the low temperature side, and ignition due to the non-aqueous electrolyte can be prevented on the high temperature side. Accordingly, it is possible to perform charging up to an optimal target state of charge adapted to the ambient temperature, and thus safety and reliability of the non-aqueous electrolyte secondary cell can be improved. The above charging control computer program can be stored in a computer-readable storage medium such as a memory, for example.

Note that an ambient temperature/target state of charge correlation characteristic is a characteristic that indicates a correlation between the ambient temperature (e.g., the temperature of a package (envelope)) of the non-aqueous electrolyte secondary cell, and the target state of charge preset with respect to that ambient temperature, as described above. The target state of charge is a unique property value that can be defined based on the structure (chemical composition, physical composition) of a cell and the ambient temperature, and represents a charging range in which safety and reliability can be secured. The target state of charge can be experimentally obtained and determined in advance.

Further, the charging control device according to the present invention is a charging control device for controlling a state of charge of a non-aqueous electrolyte secondary cell that has a non-aqueous electrolyte between electrodes, the charging control device including: a temperature detection unit for detecting an ambient temperature of the non-aqueous electrolyte secondary cell; a correlation characteristic storage unit for storing an ambient temperature/target state of charge correlation characteristic obtained by presetting a target state of charge serving as a target for stopping charging in correspondence with the ambient temperature; a target SOC extraction unit for extracting the target state of charge in correspondence with the ambient temperature detected by the temperature detection unit from the ambient temperature/target state of charge correlation characteristic; an actual SOC detection unit for detecting a state of charge of the non-aqueous electrolyte secondary cell as an actual state of charge; an SOC comparison unit for comparing the target state of charge and the actual state of charge; and a charging control unit for executing charging of the non-aqueous electrolyte secondary cell when the actual state of charge is lower than the target state of charge.

Accordingly, the charging control device according to the present invention controls the state of charge based on ambient temperature/target state of charge correlation characteristics obtained by presetting target states of charge serving as targets for stopping charging of the non-aqueous electrolyte secondary cell in correspondence with ambient temperatures. Thus, generation of a precipitate in the non-aqueous electrolyte can be prevented on the low temperature side, and ignition due to the non-aqueous electrolyte can be prevented on the high temperature side. Accordingly, it is possible to perform charging up to an optimal target state of charge adapted to the ambient temperature, and thus safety and reliability of the non-aqueous electrolyte secondary cell can be improved.

Further, the secondary cell system according to the present invention is a secondary cell system including a non-aqueous electrolyte secondary cell that has a non-aqueous electrolyte between electrodes, and a charging control device for controlling charging of the non-aqueous electrolyte secondary cell, and the charging control device is the charging control device according to the present invention.

Accordingly, the secondary cell system according to the present invention controls the state of charge based on ambient temperature/target state of charge correlation characteristics obtained by presetting target states of charge serving as targets for stopping charging of the non-aqueous electrolyte secondary cell in correspondence with ambient temperatures. Thus, generation of a precipitate in the non-aqueous electrolyte can be prevented on the low temperature side, and ignition due to the non-aqueous electrolyte can be prevented on the high temperature side. Accordingly, it is possible to perform charging up to an optimal target state of charge adapted to the ambient temperature, and thus safety and reliability of the secondary cell system can be improved.

Further, the secondary cell power supply according to the present invention is a secondary cell power supply including a secondary cell system including a non-aqueous electrolyte secondary cell that has a non-aqueous electrolyte between electrodes and a charging control device for controlling charging of the non-aqueous electrolyte secondary cell, and a charging power supply for supplying charging power for the non-aqueous electrolyte secondary cell, and the secondary cell system is the secondary cell system according to the present invention.

Accordingly, the secondary cell power supply according to the present invention achieves high safety and reliability, given the application of the secondary cell system with high safety and reliability.

Further, the cell application device according to the present invention is a cell application device equipped with a secondary cell system including a non-aqueous electrolyte secondary cell that has a non-aqueous electrolyte between electrodes and a charging control device for controlling charging of the non-aqueous electrolyte secondary cell, and the secondary cell system is the secondary cell system according to the present invention.

Accordingly, the cell application device according to the present invention achieves high safety and reliability, given that it is equipped with the secondary cell system with high safety and reliability.

### BRIEF DESCRIPTION OF THE DRAWINGS

FIG. 1A is a perspective view showing a schematic configuration of a non-aqueous electrolyte secondary cell according to Embodiment 1 of the present invention.

FIG. 1B is a perspective view showing a schematic configuration of a non-aqueous electrolyte secondary cell module obtained by modularizing the non-aqueous electrolyte secondary cell shown in FIG. 1A.

FIG. 1C is a perspective view showing a schematic configuration of a non-aqueous electrolyte secondary cell according to Embodiment 1 of the present invention.

FIG. 1D is a perspective view showing a schematic configuration of a non-aqueous electrolyte secondary cell module obtained by modularizing the non-aqueous electrolyte secondary cell shown in FIG. 1C.

FIG. 2A is a characteristics table showing ignition characteristics resulting from states of charge of the non-aqueous electrolyte secondary cell according to Embodiment 1 of the present invention and ambient temperatures on the high temperature side.

FIG. 2B is a characteristics table showing precipitate generating characteristics resulting from states of charge of the non-aqueous electrolyte secondary cell according to Embodiment 1 of the present invention and ambient temperatures on the low temperature side.

FIG. 3 is a control characteristics table showing ambient temperature/target state of charge correlation characteristics when the state of charge of the non-aqueous electrolyte secondary cell according to Embodiment 1 of the present invention is controlled in correspondence with the ambient temperature.

FIG. 4 is a flowchart showing a processing flow of a charging control computer program for controlling the state of charge of the non-aqueous electrolyte secondary cell according to Embodiment 2 of the present invention.

FIG. 5 is a block diagram showing main constituent blocks of a charging control device for controlling the state of charge of the non-aqueous electrolyte secondary cell according to Embodiment 2 of the present invention.

FIG. 6 is a characteristics diagram showing an example of charging control performed on the non-aqueous electrolyte secondary cell according to Embodiment 2 of the present invention.

FIG. 7 is a block diagram showing main constituent blocks of a secondary cell system and a secondary cell power supply according to Embodiment 3 of the present invention.

FIG. 8 is a block diagram showing main constituent blocks of a cell application device equipped with the secondary cell system according to Embodiment 4 of the present invention.

### MODE FOR CARRYING OUT THE INVENTION

Hereinafter, embodiments of the present invention are described based on the drawings.

### Embodiment 1

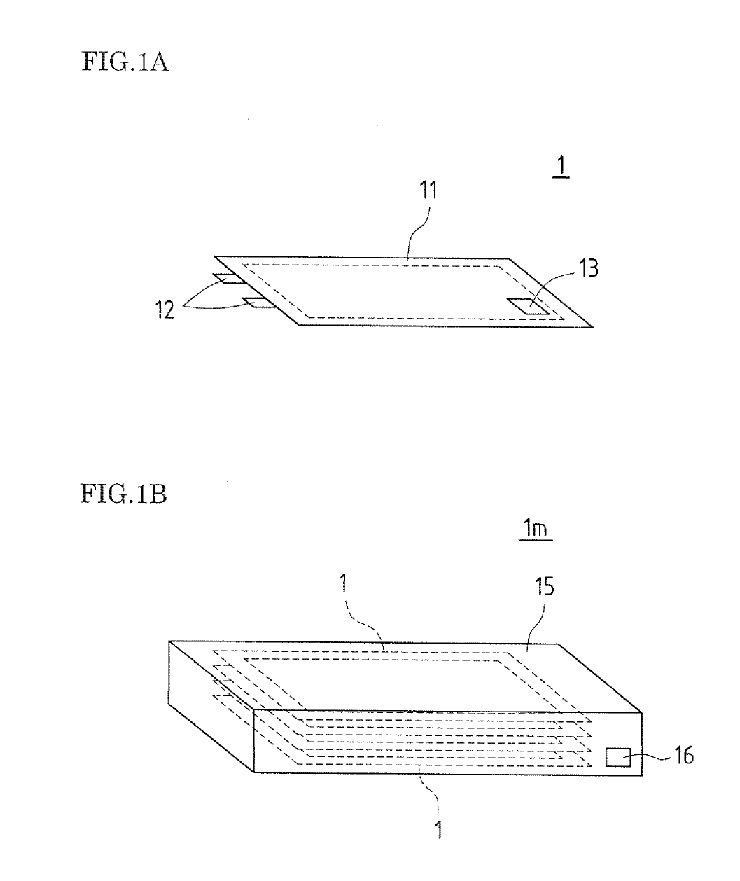

A charging control method for controlling a state of charge of a non-aqueous electrolyte secondary cell according to the present embodiment is described with reference to FIGS. 1A to 3.

FIG. 1A is a perspective view showing a schematic configuration of the non-aqueous electrolyte secondary cell according to Embodiment 1 of the present invention.

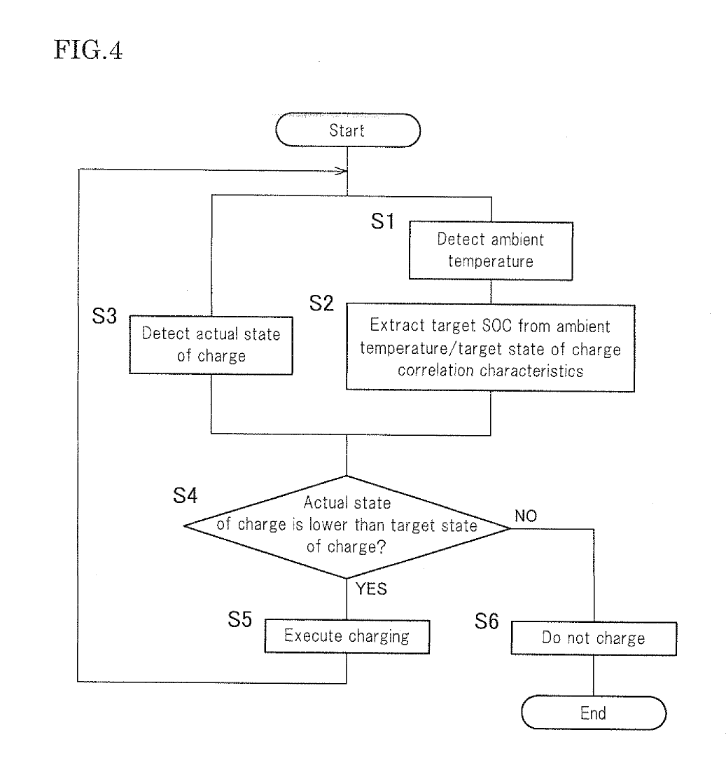

A non-aqueous electrolyte secondary cell 1 is a so-called electric cell (unit cell), and is provided with an envelope 11 for protecting the outer circumference of the main body of the non-aqueous electrolyte secondary cell 1, and exterior electrodes 12 that are drawn outside the main body of the non-aqueous electrolyte secondary cell 1, and respectively connected to a positive electrode and a negative electrode of the main body of the non-aqueous electrolyte secondary cell 1, and a temperature detection area 13 is set on the envelope 11 as an area where the temperature of the envelope 11 is detected. The temperature (surface temperature) of the envelope 11 is detected by disposing a temperature sensor 25s (see FIG. 5) in the temperature detection area 13 on the surface of the envelope 11.

The main configuration of the non-aqueous electrolyte secondary cell 1 was as follows.

Aluminum foil having a size of 290 mm×230 mm and a thickness of 20 μm was applied as the positive electrode. LiMn₂O₄ having a thickness of 100 μm was coated as an active material on portions except a part of the end portions of the both sides of the aluminum foil. Copper foil having a size of 300 mm×240 mm and a thickness of 10 μm was applied as the negative electrode. Graphite having a thickness of 60 μm was coated as an active material on portions except a part of the end portions of the both sides of the copper foil.

A laminate was formed by alternately laminating each of three positive electrodes and four negative electrodes, and putting a polyethylene separator having a size of 300×240 mm and a thickness of 25 μm between the positive and negative electrodes (void ratio=60%, air permeability=100 sec/100 cm³). An aluminum terminal and a nickel terminal (the exterior electrodes 12) were thermally fused onto the portions of the end portions of the positive and negative electrodes on which the active materials were not coated, and the laminate was sandwiched on both sides by aluminum laminate films having a size of 350 mm×270 mm each obtained by laminating aluminum foil on an insulation film, and three sides of the aluminum laminate films on both sides were thermally fused, thereby providing an opening on one side of the aluminum laminate films on both sides.

70 g (gram) of 1M-LiPF₆ (lithium hexafluorophosphate)/EC (ethylene carbonate)+DMC (dimethyl carbonate) was injected as an electrolyte from the opening on one side of the aluminum laminate films on both sides, and the space between the aluminum laminate films on both sides was sealed under reduced pressure, thereby completing the non-aqueous electrolyte secondary cell 1. The non-aqueous electrolyte secondary cell 1 constitutes a lithium ion cell since lithium salt is used in the electrolyte. The first discharge capacity of the non-aqueous electrolyte secondary cell 1 with this configuration was 9.8 Ah to 10.1 Ah.

FIG. 1B is a perspective view showing a schematic configuration of a non-aqueous electrolyte secondary cell module obtained by modularizing the non-aqueous electrolyte secondary cell shown in FIG. 1A.

A non-aqueous electrolyte secondary cell module 1m is provided with an envelope 15 including a plurality of the non-aqueous electrolyte secondary cells 1, and a temperature detection area 16 serving as an area where the temperature of the envelope 15 is detected is set on the envelope 15. The temperature (surface temperature) of the envelope 15 is detected by disposing the temperature sensor 25s (see FIG. 5) in the temperature detection area 16 on the surface of the envelope 11. Disposal is not limited to the surface of the envelope 15, and if the temperature sensor 25s is disposed between the included non-aqueous electrolyte secondary cells 1 and the envelope 15, the temperature of the inside of the envelope 15 can be detected.

Note that in the following, it is not particularly necessary to distinguish between the non-aqueous electrolyte secondary cell 1 and the non-aqueous electrolyte secondary cell module 1m, and thus except when it is necessary to particularly distinguish therebetween, description is given simply as the non-aqueous electrolyte secondary cell 1, which includes the non-aqueous electrolyte secondary cell 1 and the non-aqueous electrolyte secondary cell module 1m.

The configuration of the non-aqueous electrolyte secondary cell 1 is not limited to the example described above, and known positive electrode active materials used for lithium ion secondary cells can be used for the positive electrode. Not only a manganese-based material but also a cobalt-based material and an iron-based material can also be used, for example. Known negative electrode active materials used for lithium ion secondary cells can be used for the negative electrode. For example not only graphite but also an alloy-based negative electrode active material such as a tin oxide negative electrode active material or a silicon-based negative electrode active material can also be used.

Known materials used for lithium ion secondary cells can be used for the components of the electrolyte. The electrolyte used for a lithium ion cell is constituted by an organic solvent and lithium salt. Even if the above organic solvent contains not only ethylene carbonate and dimethyl carbonate but also one or more of the group consisting of, for example, propylene carbonate (PC), diethyl carbonate (DEC), ethyl methyl carbonate (EMC), 1,2-dimethoxyethane (DME), and acetonitrile, the organic solvent has the same characteristics in a lithium ion cell. As the above lithium salt, not only lithium hexafluorophosphate (LiPF₆) but also lithium hexafluoroborate (LiBF₆), lithium trifluoromethanesulfonate (LiCF₃SO₃), lithium trifluoroacetate (LiCF₃COO), lithium bis(trifluoromethanesulfon)imide (LiN(CF₃SO₂)₂), or the like can be used.

FIG. 1C is a perspective view showing a schematic configuration of a non-aqueous electrolyte secondary cell according to Embodiment 1 of the present invention.

FIG. 1D is a perspective view showing a schematic configuration of a non-aqueous electrolyte secondary cell module obtained by modularizing the non-aqueous electrolyte secondary cell shown in FIG. 1C.

The non-aqueous electrolyte secondary cell according to the present invention may be a wound electrode type cell, or a cylinder can type cell as shown in FIGS. 1C and 1D, despite being described as a laminated electrode type cell in FIGS. 1A and 1B.

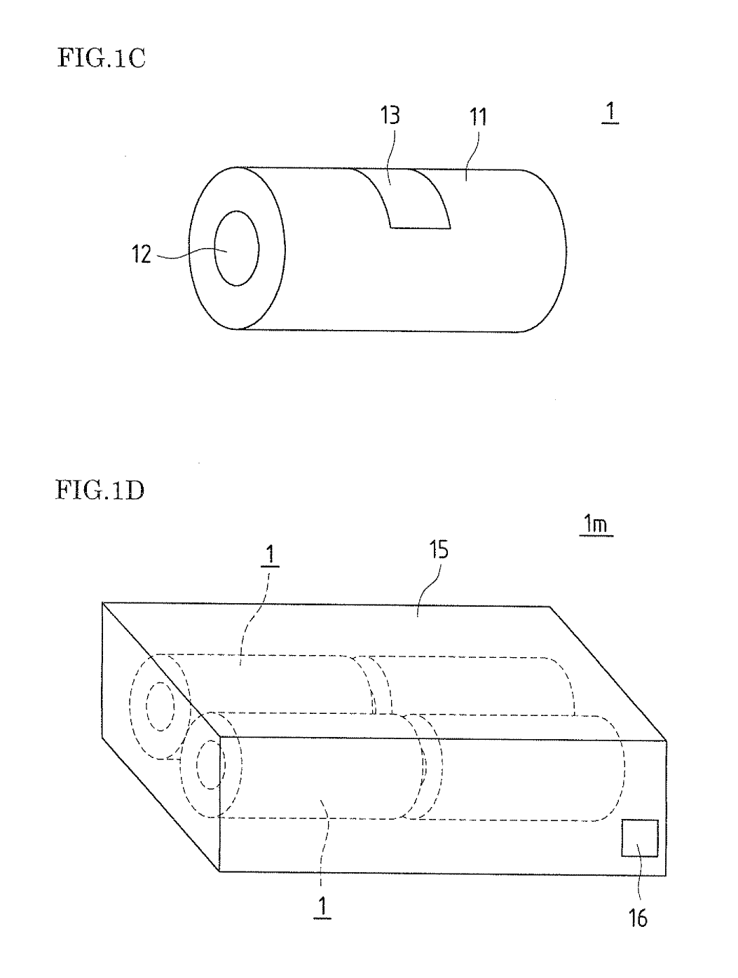

FIG. 2A is a characteristics table showing ignition characteristics resulting from states of charge of the non-aqueous electrolyte secondary cell according to Embodiment 1 of the present invention and ambient temperatures on the high temperature side.

Using three states of charge (SOCs or also referred to as charging rates), namely, 60%, 80%, and 100%, and three ambient temperatures when charging, namely, 25° C., 40° C., and 60° C., charging of the non-aqueous electrolyte secondary cell 1 was carried out with nine charging conditions based on a combination of the states of charge and the ambient temperatures. Note that the CC/CV (constant current/constant voltage) charging method was used as a charging method.

Further, the nail penetration test (ignition characteristics test) was carried out under the atmosphere of each ambient temperature, when the non-aqueous electrolyte secondary cell 1 was charged up to each state of charge (target state of charge serving as a target for stopping charging). Note that a nail penetration test is a test in which a nail is caused to penetrate a cell at a prescribed speed, and an ignition state is visually checked by observing the external appearance.

As a result, in the case where the ambient temperature was 25° C., ignition did not occur when the state of charge was any of 60%, 80%, and 100%. In the case where the ambient temperature was 40° C., ignition did not occur when the state of charge was 60% and 80%, but ignition did occur when the state of charge was 100%. In the case where the ambient temperature was 60° C., ignition did not occur when the state of charge was 60%, but ignition did occur when the state of charge was 80% and 100%.

That is, it was found that on the high temperature side (40° C. relative to 25° C., 60° C. relative to 40° C.), ignition more easily occurs the higher the state of charge. Specifically, findings were obtained indicating that the state of charge (target state of charge) is desirably decreased on the high temperature side.

The fact that an organic solvent is contained in the electrolyte of the non-aqueous electrolyte secondary cell 1 is considered to be the reason for the phenomenon in which ignition more easily occurs in the same state of charge the higher the ambient temperature. That is, the non-aqueous electrolyte secondary cell 1 contains an organic solvent in the electrolyte, which leads to a possibility of ignition due to a rise in a temperature.

Further, the energy stored in a cell greatly influences the generation of heat due to an internal short circuit that can cause ignition. That is, a full charge state having the highest energy is considered as the most dangerous state. Accordingly, the safety of a cell can be improved by lowering the state of charge on the high temperature side.

It is considered that although the critical temperature (ignition point) leading to thermal runaway (ignition) is not reached on the low temperature side even if the amount of heat generated by a cell increases to a certain extent, the critical temperature is easily reached on the high temperature side. Accordingly, the safety of the non-aqueous electrolyte secondary cell 1 can be improved by relatively lowering the state of charge on the high temperature side.

Note that when the ambient temperature was 25° C., the ignition phenomenon did not occur even though the state of charge was 100%. Thus, it is clear that the non-aqueous electrolyte secondary cell 1 according to the present embodiment is not influenced by the state of charge in terms of safety (nail penetration test) at the ambient temperature of 25° C.

FIG. 2B is a characteristics table showing precipitate generating characteristics resulting from states of charge of the non-aqueous electrolyte secondary cell according to Embodiment 1 of the present invention and ambient temperatures on the low temperature side.

Using three states of charge (SOCs), namely, 60%, 80%, and 100%, and three ambient temperatures when charging/discharging, namely, −20° C., 5° C., and 25° C., charging/discharging of the non-aqueous electrolyte secondary cell 1 was carried out with nine charge conditions based on a combination of the states of charge and the ambient temperatures (charge/discharge test). That is, the charge/discharge test (cycle test) involving repetitions of uninterrupted charging, discharging and recharging up to each state of charge (target state of charge serving as a target for stopping charging) was carried out on the non-aqueous electrolyte secondary cell 1.

500 cycles of the charge/discharge test were conducted with the charge/discharge rate (charge/discharge rate C) being 1.0 C charge/1.0 C discharge (current value for charging the rated capacity for one hour/current value for discharging the rated capacity for one hour). The three states of charge when charging (target states of charge) were used, and the depth of discharge (DOD) when discharging was 100%. The cell on which 500 cycles of charge/discharge had been performed was disassembled under an inert atmosphere, and it was confirmed whether or not a precipitate (metallic lithium) was generated.

As a result, in the case where the ambient temperature was 25° C., a precipitate was not present (was not generated) when the state of charge was any of 60%, 80%, and 100%. In the case where the ambient temperature was 5° C., a precipitate was not present (was not generated) when the state of charge was 60% and 80%, but a precipitate was present (was generated) when the state of charge was 100%. In the case where the ambient temperature was −20° C., a precipitate was not present (was not generated) when the state of charge was 60%, but a precipitate was present (was generated) when the state of charge was 80% and 100%.

That is, it was found that on the low temperature side (5° C. relative to 25° C., −20° C. relative to 5° C.), a precipitate is easily generated the higher the state of charge. A precipitate generated between the positive and negative electrodes is a cause of a short circuit between the electrodes (internal short circuit), and thus cell failure occurs, and safety on the low temperature side deteriorates. Specifically, findings were obtained indicating that the state of charge (target state of charge) is desirably decreased on the low temperature side.

Note that it is known that the capacity of a lithium ion cell that is an example of the non-aqueous electrolyte secondary cell 1 tends to drop at low temperatures. Further, if the state of charge increases at low temperatures, the possibility of precipitation of metallic lithium on the negative electrode side increases. The precipitated metallic lithium will be present between the positive and negative electrodes as foreign matter, which may damage the separator disposed between the positive and negative electrodes, and cause an internal short circuit between the positive and negative electrodes, thereby deteriorating the safety.

Accordingly, the safety of the non-aqueous electrolyte secondary cell 1 can be improved by relatively lowering the state of charge on the low temperature side so as to suppress precipitation of metallic lithium.

Note that when the ambient temperature was 25° C., a precipitate was not generated even in the case where the state of charge was 100%. Accordingly, it is clear that the non-aqueous electrolyte secondary cell 1 according to the present embodiment is not influenced by the state of charge in terms of safety (precipitate generating characteristics) at the ambient temperature of 25° C.

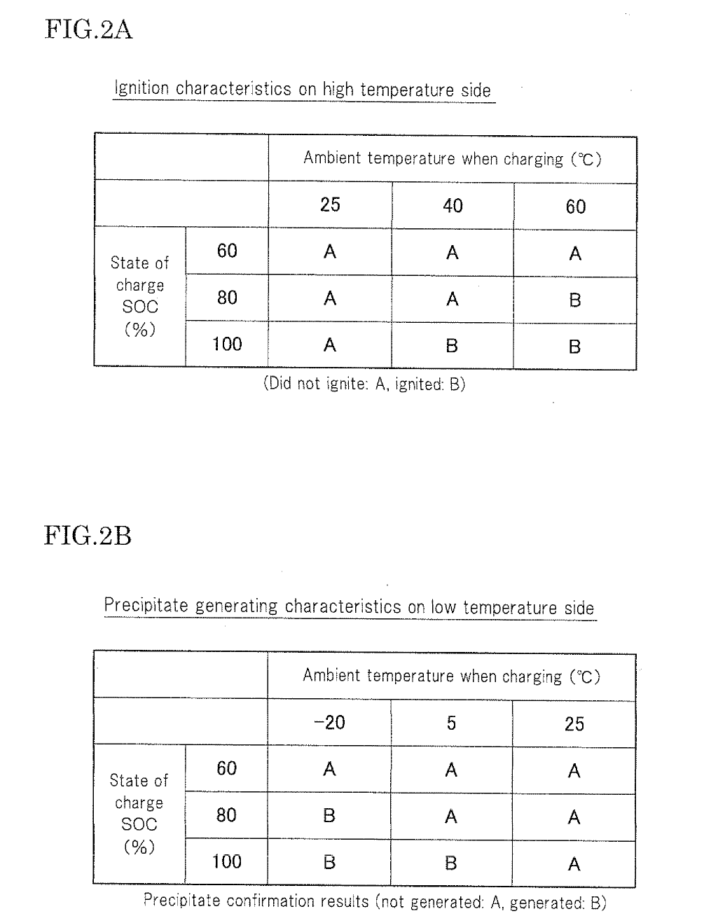

FIG. 3 is a control characteristics table showing ambient temperature/target state of charge correlation characteristics when the state of charge of the non-aqueous electrolyte secondary cell according to Embodiment 1 of the present invention is controlled in correspondence with the ambient temperature.

As described above, it has been confirmed that the non-aqueous electrolyte secondary cell 1 according to the present embodiment is not influenced by the state of charge at 25° C. Further, it was found that when the temperature is higher than 25° C. (40° C., 60° C.), safety can be improved by charging a cell up to a lower state of charge, compared to the state of charge for 25° C. Furthermore, it was found that when the temperature is lower than 25° C. (5° C., −20° C.), safety can be improved by charging a cell up to a lower state of charge, compared to the state of charge for 25° C.

The inventors of this application arrived at the following configuration as a charging control method for controlling the state of charge of the non-aqueous electrolyte secondary cell 1 according to the present embodiment, based on the findings described above.

First, 25° C., which is an ambient temperature at which safety has been confirmed for any state of charge (state of charge=100% or less), is determined as a specific temperature. Note that in the present embodiment, it is also possible to set a specific temperature having a range, for example, from 20° C. to 30° C. obtained by adding a temperature width of plus/minus 5° C. to 25° C. If the specific temperature has a temperature width (e.g., the range from 20° C. to 30° C.), the target state of charge for when the ambient temperature is within the temperature width is set to a constant value. Accordingly, the non-aqueous electrolyte secondary cell can be charged up to the highest state of charge in the case of various temperatures within the temperature width. A target state of charge SOCu serving as a target for stopping charging is set for the specific temperature of 25° C. (or the range from 20° C. to 30° C.). Although it is also possible to set the target state of charge SOCu to 100% since safety in the case where the state of charge for the specific temperature (25° C.) is 100% has been confirmed, the target state of charge SOCu was set to, for example, 95% in further consideration of safety.

On the high temperature side relative to ambient temperatures from 20° C. to 30° C., 85% for 40° C., 70% for 50° C., and 55% for 60° C., for example, were set as the target state of charge SOCu. Further, on the low temperature side relative to ambient temperatures from 20° C. to 30° C., 90% for 10° C., 80% for 0° C., 65% for −10° C., and 50% for −20° C., for example, were set as the target state of charge SOCu.

Accordingly, the ambient temperature/target state of charge correlation characteristics (FIG. 3) can be obtained by defining the horizontal axis as ambient temperature (° C.) and the vertical axis as state of charge SOC (%). The ambient temperature/target state of charge correlation characteristics can be preset by obtaining the ignition characteristics and the precipitate generating characteristics of the non-aqueous electrolyte secondary cell 1.

As described above, the charging control method for the non-aqueous electrolyte secondary cell 1 according to the present embodiment is a charging control method for controlling a state of charge of the non-aqueous electrolyte secondary cell 1 that has a non-aqueous electrolyte between electrodes, the target state of charge SOCu serving as a target for stopping charging is preset in correspondence with an ambient temperature of the non-aqueous electrolyte secondary cell 1, and the target state of charge SOCu (e.g., 95%) for when the ambient temperature is a specific temperature (e.g., 25° C. or 20° C. to 30° C.) that has been specified in advance is set higher compared to the target state of charge SOCu for a temperature other than the specific temperature.

Accordingly, with the charging control method according to the present embodiment, the target states of charge SOCu are set such that the non-aqueous electrolyte secondary cell 1 is charged up to a relatively high target state of charge SOCu when the ambient temperature is the specific temperature, and the non-aqueous electrolyte secondary cell 1 is charged up to a relatively low target state of charge SOCu compared to the target state of charge SOCu for the specific temperature when the ambient temperature is other than the specific temperature. Thus, generation of a precipitate in the non-aqueous electrolyte can be prevented at on the low temperature side, and ignition due to the non-aqueous electrolyte can be prevented on the high temperature side. Accordingly, it is possible to perform charging up to an optimal state of charge adapted to the ambient temperature, and thus safety and reliability of the non-aqueous electrolyte secondary cell 1 can be improved.

In the present embodiment, the target states of charge SOCu are set as follows.

On the low temperature side relative to the specific temperature (25° C.), a configuration is adopted in which the target state of charge SOCu also gradually increases as the ambient temperature increases, by setting the target state of charge SOCu for when the ambient temperature is −20° C. to 50%, the target state of charge SOCu for when the ambient temperature is −10° C. to 65%, the target state of charge SOCu for when the ambient temperature is 0° C. to 80%, and the target state of charge SOCu for when the ambient temperature is 10° C. to 90%.

Further, on the high temperature side relative to the specific temperature (25° C.), a configuration is adopted in which the target state of charge SOCu also gradually decreases as the ambient temperature increases, by setting the target state of charge SOCu for when the ambient temperature is 40° C. to 85%, the target state of charge SOCu for when the ambient temperature is 50° C. to 70%, and the target state of charge SOCu for when the ambient temperature is 60° C. to 55%.

That is, with the charging control method for the non-aqueous electrolyte secondary cell 1 according to the present embodiment, when the ambient temperature is lower than the specific temperature, the target state of charge SOCu is set so as to change positively with respect to a positive change in temperature (specifically, a curve indicating the change in the target state of charge relative to the change in the ambient temperature has a positive slope), and when the ambient temperature is higher than the specific temperature, the target state of charge SOCu is set so as to change negatively with respect to a positive change in temperature (specifically, a curve indicating the change in the target state of charge relative to the change in the ambient temperature has a negative slope).

Accordingly, with the charging control method according to the present invention, charging on the low temperature side and the high temperature side is controlled more effectively, and thus safety and reliability of the non-aqueous electrolyte secondary cell 1 can be further improved.

Note that in the present embodiment, the ambient temperature of the non-aqueous electrolyte secondary cell 1 is defined as follows.

That is, the ambient temperature is the temperature of the envelope 11 (e.g., the temperature detection area 13) of the non-aqueous electrolyte secondary cell 1, or the envelope 15 (e.g., the temperature detection area 16) of the non-aqueous electrolyte secondary cell module 1m that includes a plurality of the non-aqueous electrolyte secondary cells 1. Accordingly, with the charging control method according to the present embodiment, the temperature of the non-aqueous electrolyte secondary cell 1 can be directly detected, and thus charging can be controlled with ease and high precision.

Note that it is desirable that the temperature detection areas 13 and 16 are set on the surface of the envelope 11 (the envelope 15). The ambient temperature can be determined comparatively promptly by determining the temperature on the surface of the envelope 11 (the envelope 15). Further, the temperature sensor 25s can be easily disposed, which enables detection of the temperature with ease. However, the temperature detection areas 13 and 16 may be set at other proper positions rather than being limited to the surface of the envelope 11 (the envelope 15).

Further, the ambient temperature can be a temperature of the place where the non-aqueous electrolyte secondary cell 1 is disposed. For example, in the case where the non-aqueous electrolyte secondary cell 1 is disposed (installed) outdoors and directly influenced by the outside air temperature, the temperature of the place where the non-aqueous electrolyte secondary cell 1 has been disposed can be used as the ambient temperature.

In this case, with the charging control method according to the present embodiment, the state of charge can be controlled before the non-aqueous electrolyte secondary cell 1 is influenced by and reaches a state of equilibrium with the temperature of the place where the cell is disposed (outdoor temperature), and in the case where the cell is installed outdoors, for example, the state of charge can be controlled to reflect the temperature in the outdoor environment.

The non-aqueous electrolyte secondary cell 1 according to the present embodiment is specifically a lithium ion cell. Thus, with the charging control method according to the present embodiment, charging control on lithium ion cells can be performed in the state where high safety and reliability are secured.

Further, the specific temperature in the present embodiment can be set in a range, for example, from 5° C. to 40° C., rather than being limited to 25° C. described above (or 20° C. to 30° C. when given an appropriate range). Thus, with the charging control method according to the present invention, safety and reliability of the non-aqueous electrolyte secondary cell 1 can be reliably improved with regard to various target states of charge SOCu.

That is, in the present embodiment, it has been confirmed that ignition does not occur in the range from the low temperature side up to 40° C. in the case where the target state of charge SOCu is suppressed so as to be 80% or less (see FIG. 2A). Thus, it is possible to extend the range of the specific temperature up to 40° C. on the high temperature side in the case where the target state of charge SOCu is set to 80% or less. Further, it has been confirmed that a precipitate is not generated in the range from the high temperature side down to 5° C. in the case where the target state of charge SOCu is suppressed so as to be 80% or less (see FIG. 2B). Thus, it is possible to extend the range of the specific temperature to 5° C. on the low temperature side in the case where the target state of charge SOCu is set to 80% or less.

Further, it is considered that the specific temperature for the non-aqueous electrolyte secondary cell 1 varies due to the material constituting the non-aqueous electrolyte secondary cell 1 and the structure thereof. Accordingly, variation of the specific temperature due to the material of the non-aqueous electrolyte secondary cell 1 and the structure thereof can be compensated for by extending the range of the specific temperature (by setting the range, e.g., from 20° C. to 30° C. as shown in FIG. 3, rather than the point 25° C.), and thus the charging control method according to the present embodiment can be applied to various non-aqueous electrolyte secondary cells.

Further, by extending the range of the specific temperature, the charging control method according to the present embodiment can be applied to non-aqueous electrolyte secondary cells having other structures (other materials), rather than being limited to the case of the non-aqueous electrolyte secondary cell 1 according to the present embodiment. The charging control method can be applied to the case where a cell has characteristics where the specific temperature is other than 25° C., for example.

### Embodiment 2

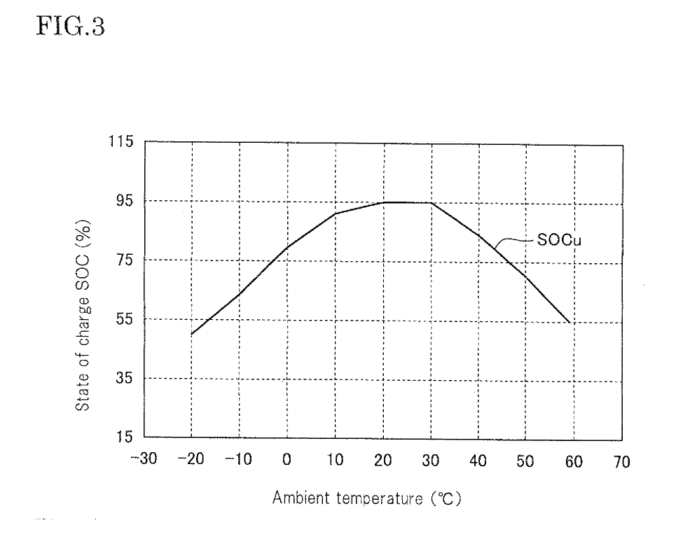

A charging control computer program and a charging control device for controlling the state of charge of a non-aqueous electrolyte secondary cell according to the present embodiment will be described based on FIGS. 4 to 6. Note that since the non-aqueous electrolyte secondary cell 1 serving as a target for charging control is the same as in the case of Embodiment 1, the same reference numerals are employed where appropriate, and different items are mainly described.

FIG. 4 is a flowchart showing a processing flow of a charging control computer program for controlling the state of charge of a non-aqueous electrolyte secondary cell according to Embodiment 2 of the present invention.

FIG. 5 is a block diagram showing main constituent blocks of a charging control device for controlling the state of charge of the non-aqueous electrolyte secondary cell according to Embodiment 2 of the present invention.

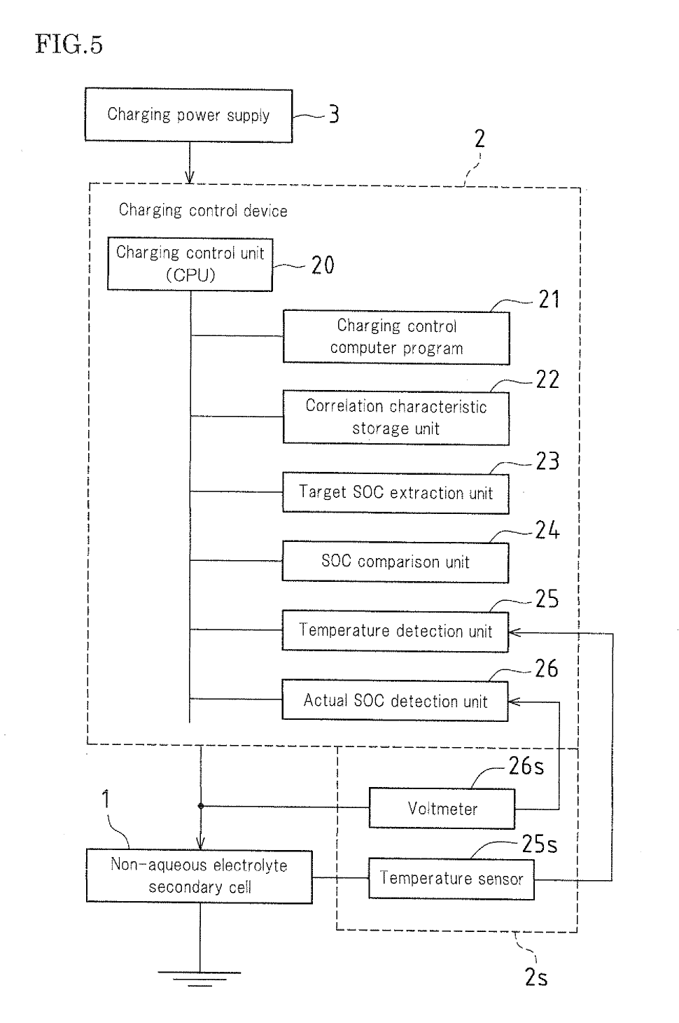

FIG. 6 is a characteristics diagram showing an example of charging control performed on the non-aqueous electrolyte secondary cell according to Embodiment 2 of the present invention.

The charging control computer program (FIG. 4) according to the present embodiment is executed by a charging control device 2 (FIG. 5) that includes a computer (the charging control device 2, a charging control unit 20 constituted by a CPU). Further, an example of specific charging control (FIG. 6) is also described.

First, the charging control computer program (steps S1 to S6 in FIG. 4) executed by the computer (the charging control device 2, the charging control unit 20) is described.

The charging control computer program according to the present embodiment is a charging control computer program that causes the computer to execute control of a state of charge of the non-aqueous electrolyte secondary cell 1 that has a non-aqueous electrolyte between electrodes, and the processing of the following steps S1 to S6 is executed.

Step S1

The ambient temperature of the non-aqueous electrolyte secondary cell 1 is detected (first step). The ambient temperature is detected by a temperature detection unit 25 (FIG. 5) via the temperature sensor 25s (FIG. 5) disposed adjacent to the non-aqueous electrolyte secondary cell 1 (the temperature detection area 13, the temperature detection area 16). After detecting the ambient temperature, the processing proceeds to step S2.

Step S2

The target state of charge SOCu in correspondence with the ambient temperature detected in the first step (step S1) is extracted (second step) from ambient temperature/target state of charge correlation characteristics (FIGS. 3 and 6) obtained by presetting target states of charge SOCu serving as targets for stopping charging (FIGS. 3 and 6) in correspondence with ambient temperatures.

The ambient temperature/target state of charge correlation characteristics are preset and stored in a correlation characteristic storage unit 22. Accordingly, this step is executed by reading out data stored in the correlation characteristic storage unit 22.

Step S3

The state of charge of the non-aqueous electrolyte secondary cell 1 is detected as an actual state of charge SOCr (FIG. 6) (third step). The actual state of charge SOCr is detected by an actual SOC detection unit 26 (FIG. 5) via a voltmeter 26s, for example. After detecting the actual state of charge SOCr, the processing proceeds to step S4.

Note that although this step can be carried out in parallel to steps S1 and S2, it is possible to carry out step S3 at a timing either before or after steps S1 and S2.

Further, although the voltmeter 26s is adopted as a detection means for detecting the actual state of charge SOCr, it is also possible to adopt other detection means as appropriate.

Step S4

Based on the ambient temperature/target state of charge correlation characteristics that have been preset and stored in the correlation characteristic storage unit 22, the target state of charge SOCu that has been extracted in correspondence with the detected ambient temperature and the actual state of charge SOCr showing the actual state of charge are compared to each other (fourth step). That is, it is determined whether or not the actual state of charge SOCr is lower than the target state of charge SOCu.

This step is executed by an SOC comparison unit 24.

Step S5

When the actual state of charge SOCr is lower than the target state of charge SOCu, charging of the non-aqueous electrolyte secondary cell 1 is executed (fifth step). This step is executed by the charging control unit 20.

Step S6

When the actual state of charge SOCr is equal to or greater than the target state of charge SOCu, the processing (computer program) ends (sixth step) without charging the non-aqueous electrolyte secondary cell 1.

As described above, the charging control computer program according to the present embodiment is a charging control computer program for causing a computer to execute control of a state of charge of the non-aqueous electrolyte secondary cell 1 that has a non-aqueous electrolyte between electrodes, the computer program causing the computer to execute: a first step of detecting an ambient temperature of the non-aqueous electrolyte secondary cell 1; a second step of extracting, from an ambient temperature/target state of charge correlation characteristic obtained by presetting the target state of charge SOCu serving as a target for stopping charging in correspondence with the ambient temperature, the target state of charge SOCu in correspondence with the ambient temperature detected in the first step; a third step of detecting a state of charge of the non-aqueous electrolyte secondary cell 1 as the actual state of charge SOCr; a fourth step of comparing the target state of charge SOCu and the actual state of charge SOCr; and a fifth step of executing charging of the non-aqueous electrolyte secondary cell 1 when the actual state of charge SOCr is lower than the target state of charge SOCu.

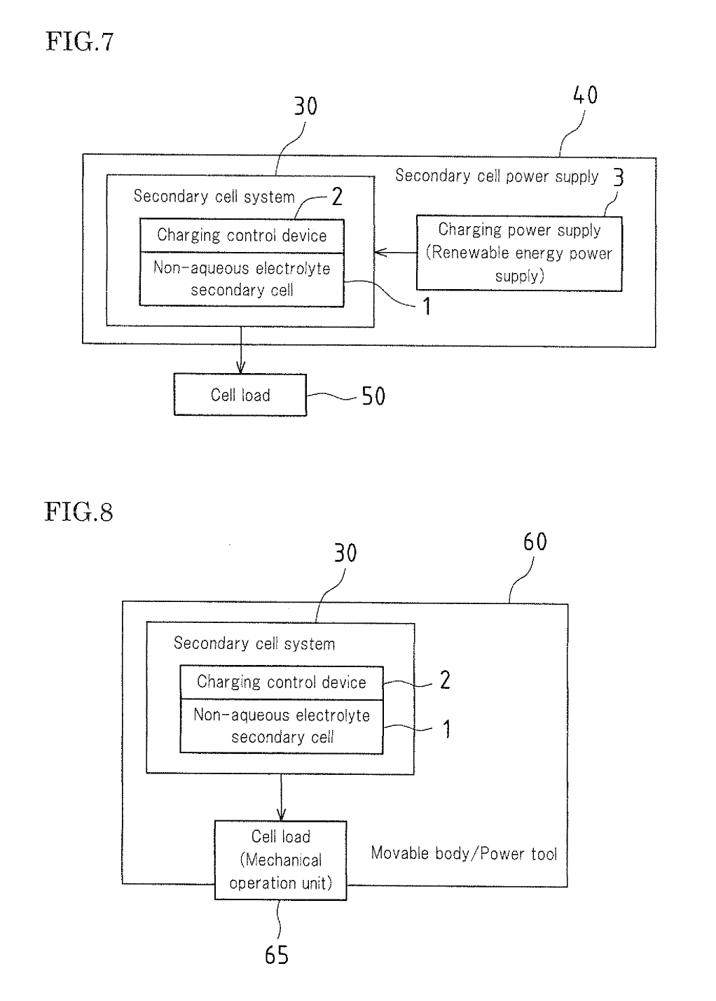

Accordingly, with the charging control computer program according to the present embodiment, a state of charge is controlled based on ambient temperature/target state of charge correlation characteristics obtained by presetting target states of charge SOCu serving as targets for stopping charging of the non-aqueous electrolyte secondary cell 1 in correspondence with ambient temperatures (correlation characteristics between ambient temperatures shown by the horizontal axis and target states of charge SOCu shown by the vertical axis in FIG. 8). Thus, generation of a precipitate in the non-aqueous electrolyte can be prevented on the low temperature side, and ignition due to the non-aqueous electrolyte can be prevented on the high temperature side. Accordingly, it is possible to perform charging up to an optimal target state of charge SOCu adapted to the ambient temperature, and thus safety and reliability of the non-aqueous electrolyte secondary cell 1 can be improved.

Next, the configuration of the charging control device 2 (FIG. 5) will be described. The charging control device 2 according to the present embodiment is provided with the charging control unit 20 that includes a CPU (central processing unit) as the hardware resource for executing the charging control computer program. That is, the charging control device 2 (the charging control unit 20) operates as a computer.

Further, the charging control unit 20 stores a charging control computer program 21 in a program storage unit (a computer-readable storage medium), and is provided with the correlation characteristic storage unit 22, a target SOC extraction unit 23, the SOC comparison unit 24, the temperature detection unit 25, and the actual SOC detection unit 26, as means for specifically executing the charging control computer program 21.

The correlation characteristic storage unit 22 can be constituted by, for example, a writable memory such as a flash memory, and the ambient temperature/target state of charge correlation characteristics that the non-aqueous electrolyte secondary cell 1 has as unique values can be written therein from outside as appropriate. The target SOC extraction unit 23 and the SOC comparison unit 24 can be realized as computational functionality of the charging control unit 20.

The temperature detection unit 25 is connected to the temperature sensor 25s for detecting the temperature of the non-aqueous electrolyte secondary cell 1, and detects the temperature of the non-aqueous electrolyte secondary cell 1 as processable data, based on information from the temperature sensor 25s. The actual SOC detection unit 26 is connected to the voltmeter 26s for detecting the voltage of the non-aqueous electrolyte secondary cell 1, and detects the actual state of charge SOCr of the non-aqueous electrolyte secondary cell 1 as processable data, based on information from the voltmeter 26s.

Note that the temperature sensor 25s and the voltmeter 26s can be externally provided as a sensor unit 2s on the external portion of the charging control device 2. Further, the sensor unit 2s and the charging control device 2 can be integrated.

The temperature sensor 25s can detect temperature by applying, for example, a thermistor or the like and converting the temperature into a resistance value. Further, the voltmeter 26s can generate a voltage signal by performing voltage division on a high resistance, and detect the actual state of charge SOCr by detecting the voltage of the non-aqueous electrolyte secondary cell 1 based on the voltage signal. A configuration is adopted in which the temperature sensor 25s and the voltmeter 26s are connected to the non-aqueous electrolyte secondary cell 1, and transmit signals to the temperature detection unit 25 and the actual SOC detection unit 26 via appropriate signal lines.

Further, the charging control device 2 supplies, to the non-aqueous electrolyte secondary cell 1, charging power supplied from a charging power supply 3 to charge the non-aqueous electrolyte secondary cell 1, thereby executing charging control. Note that, for example, a direct current power supply obtained by rectifying an alternating current power supply (commercial power supply), a renewable energy power supply utilizing renewable energy, or the like is applicable as appropriate as the charging power supply 3 in the present embodiment.

That is, the charging control device 2 according to the present embodiment is the charging control device 2 for controlling a state of charge of the non-aqueous electrolyte secondary cell 1 that has a non-aqueous electrolyte between electrodes, the charging control device including: the temperature detection unit 25 for detecting an ambient temperature of the non-aqueous electrolyte secondary cell 1; the correlation characteristic storage unit 22 for storing an ambient temperature/target state of charge correlation characteristic (FIG. 6) obtained by presetting the target state of charge SOCu (FIG. 6) serving as a target for stopping charging in correspondence with the ambient temperature; the target SOC extraction unit 23 for extracting the target state of charge SOCu in correspondence with the ambient temperature detected by the temperature detection unit 25 from the ambient temperature/target state of charge correlation characteristic; the actual SOC detection unit 26 for detecting a state of charge of the non-aqueous electrolyte secondary cell 1 as the actual state of charge SOCr (FIG. 6); the SOC comparison unit 24 for comparing the target state of charge SOCu and the actual state of charge SOCr; and the charging control unit 20 for executing charging of the non-aqueous electrolyte secondary cell 1 when the actual state of charge SOCr is lower than the target state of charge SOCu.

Accordingly, the charging control device 2 according to the present embodiment controls the state of charge based on ambient temperature/target state of charge correlation characteristics obtained by presetting target states of charge SOCu serving as targets for stopping charging of the non-aqueous electrolyte secondary cell 1 in correspondence with ambient temperatures. Thus, generation of a precipitate in the non-aqueous electrolyte can be prevented on the low temperature side, and ignition due to the non-aqueous electrolyte can be prevented on the high temperature side. Accordingly, it is possible to perform charging up to an optimal target state of charge SOCu adapted to the ambient temperature, and thus safety and reliability of the non-aqueous electrolyte secondary cell 1 can be improved.

Next is a description of an aspect in which the non-aqueous electrolyte secondary cell 1 is charged based on the relationship between the target state of charge SOCu and the actual state of charge SOCr, with reference to FIG. 6 (the ambient temperature/target state of charge correlation characteristics, correlation characteristics between ambient temperatures on the horizontal axis and target states of charge on the vertical axis shown by a curve SOCu).

In the ambient temperature/target state of charge correlation characteristics according to the present embodiment, the followings are preset: for example, the target state of charge is SOCu8 when the ambient temperature is T1(° C.); the target state of charge is SOCu6 when the ambient temperature is T2(° C.); the target state of charge is SOCu4 when the ambient temperature is T3(° C.); the target state of charge is SOCu2 when the ambient temperature is T4(° C.); the target state of charge is SOCu1 when the ambient temperature is T5(° C.); the target state of charge is SOCu1 when the ambient temperature is T6(° C.); the target state of charge is SOCu3 when the ambient temperature is T7(° C.); the target state of charge is SOCu5 when the ambient temperature is T8(° C.); and the target state of charge is SOCu7 when the ambient temperature is T9(° C.).

That is, with the target state of charge SOCu1 at the time of the ambient temperature T5 and the target state of charge SOCu1 at the time of the ambient temperature T6 being set as the maximum value (maximal value), the relationship of target states of charge on the low temperature side is such that the target state of charge SOCu8<the target state of charge SOCu6<the target state of charge SOCu4<the target state of charge SOCu2<the target state of charge SOCu1, and the relationship of target states of charge on the high temperature side is such that the target state of charge SOCu1>the target state of charge SOCu3>the target state of charge SOCu5>the target state of charge SOCu7. That is, the ambient temperature/target state of charge correlation characteristics form an upward convex curve (chevron curve) with respect to the horizontal axis, with the target state of charge SOCu1 being the maximal value.

Note that the relationship of ambient temperatures is such that T1<T2<T3<T4<T5<T6<T7<T8<T9, and T5 and T6 can be, for example, 20° C. and 30° C. as the specific temperature, as in the case of FIG. 3. Further, the ambient temperature can be set as necessary in a stepwise manner, on a 5° C. basis, a 10° C. basis, or the like. If an intermediate temperature is detected, an appropriate target state of charge SOCu can be extracted (computed) applying the complement method (extrapolation method). Here, although nine points of ambient temperatures are shown as representative examples, the intervals therebetween may be further subdivided.

A description is given on charging control in the case where, for example, the actual state of charge is SOCr4 when the ambient temperature is T1(° C.), the actual state of charge is SOCr6 when the ambient temperature is T2(° C.), the actual state of charge is SOCr9 when the ambient temperature is T3(° C.), the actual state of charge is SOCr8 when the ambient temperature is T4(° C.), the actual state of charge is SOCr3 when the ambient temperature is T5(° C.), the actual state of charge is SOCr7 when the ambient temperature is T6(° C.), the actual state of charge is SOCr2 when the ambient temperature is T7(° C.), the actual state of charge is SOCr1 when the ambient temperature is T8(° C.), and the actual state of charge is SOCr5 when the ambient temperature is T9(° C.).

When the ambient temperature is T1, charging from the actual state of charge SOCr4 to the target state of charge SOCu8 is executed as the arrow indicates. When the ambient temperature is T2, charging from the actual state of charge SOCr6 to the target state of charge SOCu6 is executed as the arrow indicates. When the ambient temperature is T3, charging from the actual state of charge SOCr9 to the target state of charge SOCu4 is executed as the arrow indicates. When the ambient temperature is T4, charging from the actual state of charge SOCr8 to the target state of charge SOCu2 is executed as the arrow indicates. When the ambient temperature is T5, charging from the actual state of charge SOCr3 to the target state of charge SOCu1 is executed as the arrow indicates. When the ambient temperature is T6, charging from the actual state of charge SOCr7 to the target state of charge SOCu1 is executed as the arrow indicates. When the ambient temperature is T7, charging from the actual state of charge SOCr2 to the target state of charge SOCu3 is executed as the arrow indicates. When the ambient temperature is T9, charging from the actual state of charge SOCr5 to the target state of charge SOCu7 is executed as the arrow indicates.

Further, when ambient temperature is T8, since the actual state of charge SOCr1 is a state of charge higher than the target state of charge SOCu5, charging is not necessary (inappropriate), and thus charging control ends without executing charging.

As described above, with the charging control method according to the present embodiment, the target state of charge SOCu preset in correspondence with the ambient temperature and the actual state of charge SOCr indicating the actual state of charge are compared to each other, and charging is performed in accordance with an deficient amount of charge, thereby achieving a charging control method with high safety and reliability. Further, the target state of charge SOCu for the specific temperature, which is a temperature at which safety can be reliably secured, is determined as being the upper limit, and with regard to temperatures other than the specific temperature, lower target states of charge SOCu are set on both the high temperature side and the low temperature side, and thus safety and reliability can be reliably secured.

Note that although a description has been given with reference to FIG. 6 on the states of charge (charging control) in a simplified case in which the ambient temperature is constant, the ambient temperature may vary partway through charging control. To cope with such a case, it is sufficient to shorten the execution period of step S3 (detection of the actual state of charge), step S4 (comparison between the actual state of charge and the target state of charge), and step S5 (execution of charging), which are shown in FIG. 4.

### Embodiment 3

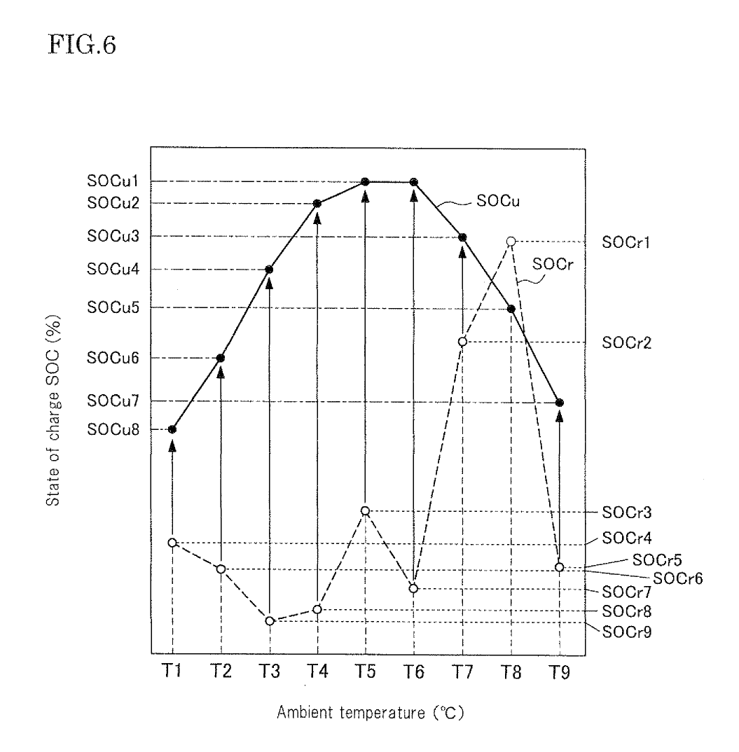

A secondary cell system according to the present embodiment, and a secondary cell power supply according thereto to which the secondary cell system is applied are described based on FIG. 7. Note that since the non-aqueous electrolyte secondary cell, the charging control device, and the charging power supply are the same as the cases in Embodiments 1 and 2, the same reference numerals are employed where appropriate, and different items are mainly described.

FIG. 7 is a block diagram showing main constituent blocks of a secondary cell system and a secondary cell power supply according to Embodiment 3 of the present invention.

A secondary cell system 30 is constituted with the non-aqueous electrolyte secondary cell 1 being provided with the charging control device 2. Further, a secondary cell power supply 40 is constituted with the charging power supply 3 being connected to the secondary cell system 30, and charging power being supplied from the charging power supply 3 to the secondary cell system 30. A cell load 50 serving as a load is connected to the secondary cell system 30 (the non-aqueous electrolyte secondary cell 1).

The secondary cell system 30 according to the present embodiment is provided with the non-aqueous electrolyte secondary cell 1 that has a non-aqueous electrolyte between electrodes, and the charging control device 2 for controlling charging of the non-aqueous electrolyte secondary cell 1. Further, the charging control device 2 described in Embodiment 2 (Embodiment 1) is directly applicable as the charging control device 2.

Accordingly, the secondary cell system 30 according to the present embodiment controls the state of charge based on ambient temperature/target state of charge correlation characteristics (FIGS. 3 and 6) obtained by presetting target states of charge SOCu (FIGS. 3 and 6) serving as targets for stopping charging of the non-aqueous electrolyte secondary cell 1 in correspondence with ambient temperatures. Thus, generation of a precipitate in the non-aqueous electrolyte can be prevented on the low temperature side, and ignition due to the non-aqueous electrolyte can be prevented on the high temperature side. Accordingly, it is possible to perform charging up to an optimal target state of charge SOCu adapted to the ambient temperature, and thus safety and reliability of the secondary cell system 30 can be improved.

The secondary cell system 30 can be equipped in, for example, portable electronic devices and movable bodies/power tools (Embodiment 4) described later, for instance.

Further, the secondary cell power supply 40 according to the present embodiment is provided with the secondary cell system 30 provided with the non-aqueous electrolyte secondary cell 1 that has a non-aqueous electrolyte between electrodes, and the charging control device 2 for controlling charging of the non-aqueous electrolyte secondary cell 1, and the charging power supply 3 for supplying charging power for the non-aqueous electrolyte secondary cell 1.

Accordingly, the secondary cell power supply 40 according to the present invention achieves the secondary cell power supply 40 with high safety and reliability, given application of the secondary cell system 30 with high safety and reliability.

Note that it is desirable that a renewable energy power supply (renewable energy power generation system) utilizing renewable energy is applied as the charging power supply 3. The efficient and economical secondary cell power supply 40 is achieved by utilizing a renewable energy power supply.

As a specific example of a renewable energy power supply, a solar power generation system, a wind power generation system, a hydroelectric power generation system, a geothermal power generation system, a biomass power generation system, a snow ice cryogenic energy power generation system, an ocean thermal energy conversion system, a tidal power generation system, or the like is applicable. A fossil fuel power generation system (thermal power generation system), a nuclear power generation system, or the like is applicable as necessary.

Accordingly, the secondary cell power supply 40 can be realized as, for example, a power plant, a home power supply system (solar power generation system), or the like, in the case of being a large-scale facility.

### Embodiment 4

A cell application device (a device serving as a cell load, such as a movable body, a power tool, for example) according to the present embodiment is described based on FIG. 8. That is, a cell application device (a movable body, a power tool) equipped with the secondary cell system 30 (the non-aqueous electrolyte secondary cell 1, the charging control device 2) according to Embodiments 1 to 3 is described. With regard to the non-aqueous electrolyte secondary cell 1, the charging control device 2, and the secondary cell system 30, the same reference numerals are employed where appropriate, and different items are mainly described. Note that a movable body and a power tool as a cell application device are in common with each other in that each is provided with the secondary cell system 30 (the non-aqueous electrolyte secondary cell 1, the charging control device 2). Since their mechanical operation units serving as a cell load merely differ from each other, both are described collectively as specific examples of a cell application device according to the present embodiment.

FIG. 8 is a block diagram showing main constituent blocks of the cell application device equipped with the secondary cell system according to Embodiment 4 of the present invention.

A cell application device 60 (movable body) according to the present embodiment includes, as a cell load 65, a mechanical operation unit (a wheel driving unit or the like) required by a movable body. The cell application device 60 (movable body) is equipped with the secondary cell system 30 provided with the non-aqueous electrolyte secondary cell 1 that has a non-aqueous electrolyte between electrodes, and the charging control device 2 for controlling charging of the non-aqueous electrolyte secondary cell 1. Further, the secondary cell system 30 is the secondary cell system 30 described in Embodiment 3.

Accordingly, the cell application device 60 (movable body) according to the present invention achieves a movable body (the cell application device 60) with high safety and reliability, given that it is equipped with the secondary cell system 30 with high safety and reliability.

Note that examples of the movable body include an automobile, a train, an electric motorcycle, an electric bike, a forklift, a boat, a ferry, a plane, and a balloon, and the secondary cell system 30 (the non-aqueous electrolyte secondary cell 1, the charging control device 2) is similarly applicable to any of these movable bodies.

The cell application device 60 (power tool) according to the present embodiment includes, as the cell load 65, a mechanical operation unit (a rotation driving unit that rotates a drill or the like) required as a power tool. The cell application device 60 (power tool) is equipped with the secondary cell system 30 provided with the non-aqueous electrolyte secondary cell 1 that has a non-aqueous electrolyte between electrodes, and the charging control device 2 for controlling charging of the non-aqueous electrolyte secondary cell 1. Further, the secondary cell system 30 is the secondary cell system 30 described in Embodiment 3.

Accordingly, the cell application device 60 (power tool) according to the present invention achieves a power tool (the cell application device 60) with high safety and reliability, given that it is equipped with the secondary cell system 30 with high safety and reliability.

Note that examples of the power tool include an electric drill and an electric saw, and the secondary cell system 30 (the non-aqueous electrolyte secondary cell 1, the charging control device 2) is similarly applicable to any of these power tools.

As described above, the cell application device 60 according to the present embodiment is the cell application device 60 (a movable body, a power tool) equipped with the secondary cell system 30 provided with the non-aqueous electrolyte secondary cell 1 that has a non-aqueous electrolyte between electrodes, and the charging control device 2 for controlling charging of the non-aqueous electrolyte secondary cell 1, and the secondary cell system is the secondary cell system 30 described in Embodiment 3.

Accordingly, the cell application device 60 according to the present invention achieves a cell application device with high safety and reliability, given that it is equipped with the secondary cell system 30 with high safety and reliability.

Further, it is desirable that the cell application device 60 is a movable body or a power tool as described above.

The present invention may be embodied in various other forms without departing from the gist or essential characteristics thereof. Therefore, the embodiments disclosed herein are to be considered in all respects as illustrative and not limiting. The scope of the invention is indicated by the appended claims rather than by the foregoing description. All variations and modifications that come within the meaning and range of equivalency of the claims are intended to be embraced therein.

What is claimed is:

1. A charging control method for controlling a state of charge of a non-aqueous electrolyte secondary cell that has a non-aqueous electrolyte between electrodes,
wherein a target state of charge serving as a target for stopping charging is preset in correspondence with an ambient temperature of the non-aqueous electrolyte secondary cell, and
the target state of charge for when the ambient temperature is a specific temperature that has been specified in advance is set higher compared to the target state of charge for a temperature other than the specific temperature.

2. The charging control method according to claim 1,
wherein when the ambient temperature is lower than the specific temperature, the target state of charge is set so as to change positively with respect to a positive change in temperature, and when the ambient temperature is higher than the specific temperature, the target state of charge is set so as to change negatively with respect to a positive change in temperature.

3. The charging control method according to claim 1,
wherein the ambient temperature is a temperature of an envelope of the non-aqueous electrolyte secondary cell, or a temperature of an envelope of a secondary cell module that includes a plurality of the non-aqueous electrolyte secondary cells.

4. The charging control method according to claim 2,
wherein the ambient temperature is a temperature of an envelope of the non-aqueous electrolyte secondary cell, or a temperature of an envelope of a secondary cell module that includes a plurality of the non-aqueous electrolyte secondary cells.

5. The charging control method according to claim 1,
wherein the ambient temperature is a temperature of a place where the non-aqueous electrolyte secondary cell is disposed.

6. The charging control method according to claim 2,
wherein the ambient temperature is a temperature of a place where the non-aqueous electrolyte secondary cell is disposed.

7. The charging control method according to claim 1,
wherein the non-aqueous electrolyte secondary cell is a lithium ion cell.

8. The charging control method according to claim 2,
wherein the non-aqueous electrolyte secondary cell is a lithium ion cell.

9. The charging control method according to claim 1,
wherein the specific temperature is in a range from 5° C. to 40° C.

10. The charging control method according to claim 2,
wherein the specific temperature is in a range from 5° C. to 40° C.

11. The charging control method according to claim 1,
wherein the specific temperature has a temperature width, and
the target state of charge for when the ambient temperature is within the temperature width is set to a constant value.

12. The charging control method according to claim 2,
wherein the specific temperature has a temperature width, and
the target state of charge for when the ambient temperature is within the temperature width is set to a constant value.

13. A charging control computer program stored in a computer-readable storage medium and for causing a computer to execute control of a state of charge of a non-aqueous electrolyte secondary cell that has a non-aqueous electrolyte between electrodes, the computer program causing the computer to execute:
a first step of detecting an ambient temperature of the non-aqueous electrolyte secondary cell;
a second step of extracting, from an ambient temperature/target state of charge correlation characteristic obtained by presetting a target state of charge serving as a target for stopping charging in correspondence with the ambient temperature, the target state of charge in correspondence with the ambient temperature detected in the first step;
a third step of detecting a state of charge of the non-aqueous electrolyte secondary cell as an actual state of charge;
a fourth step of comparing the target state of charge and the actual state of charge; and
a fifth step of executing charging of the non-aqueous electrolyte secondary cell when the actual state of charge is lower than the target state of charge.

14. A charging control device for controlling a state of charge (SOC) of a non-aqueous electrolyte secondary cell that has a non-aqueous electrolyte between electrodes, the charging control device comprising:
a temperature detection unit for detecting an ambient temperature of the non-aqueous electrolyte secondary cell;
a correlation characteristic storage unit for storing an ambient temperature/target state of charge correlation characteristic obtained by presetting a target state of charge serving as a target for stopping charging in correspondence with the ambient temperature;
a target SOC extraction unit for extracting the target state of charge in correspondence with the ambient temperature detected by the temperature detection unit from the ambient temperature/target state of charge correlation characteristic;
an actual SOC detection unit for detecting a state of charge of the non-aqueous electrolyte secondary cell as an actual state of charge;
an SOC comparison unit for comparing the target state of charge and the actual state of charge; and
a charging control unit for executing charging of the non-aqueous electrolyte secondary cell when the actual state of charge is lower than the target state of charge.

15. A secondary cell system comprising a non-aqueous electrolyte secondary cell that has a non-aqueous electrolyte between electrodes, and a charging control device for controlling charging of the non-aqueous electrolyte secondary cell,
wherein the charging control device is the charging control device according to claim 14.

16. A secondary cell power supply comprising a secondary cell system including a non-aqueous electrolyte secondary cell that has a non-aqueous electrolyte between electrodes and a charging control device for controlling charging of the non-aqueous electrolyte secondary cell, and a charging power supply for supplying charging power for the non-aqueous electrolyte secondary cell,
wherein the secondary cell system is the secondary cell system according to claim 15.

17. A cell application device equipped with a secondary cell system including a non-aqueous electrolyte secondary cell that has a non-aqueous electrolyte between electrodes and a charging control device for controlling charging of the non-aqueous electrolyte secondary cell,
wherein the secondary cell system is the secondary cell system according to claim 15.
